(19) United States
(12) Patent Application Publication
(10) Pub. No.: US 2001/0053451 A1
(43) Pub. Date: Dec. 20, 2001

(54) Laminated product and process for producing the same

(76) Inventors: Yoshiaki Togawa, Kyoto-shi (JP); Tohru Yabe, Ichihara-shi (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/818,515

(22) Filed: Mar. 28, 2001

(30) Foreign Application Priority Data
Mar. 30, 2000 (JP) 2000-093950
Mar. 30, 2000 (JP) 2000-093951

(51) Int. Cl. C08K 3/40; B32B 15/08

(52) U.S. Cl. 428/461; 524/494

(57) ABSTRACT

There are disclosed:

(1) a laminated product comprising:

(i) a layer containing a glass fiber reinforced thermoplastic resin; and

(ii) a layer containing a metal plate, and

(2) a process for producing a laminated product, which comprises the steps of:

(i) setting a layer containing a metal plate in a mold cavity,

(ii) closing the mold,

(iii) supplying a molten resin of a glass fiber reinforced thermoplastic resin pellet in the mold cavity,

(iv) cooling and solidifying the supplied resin, and

(v) taking out a laminated product from the mold cavity.

### FIELD OF THE INVENTION

The present invention relates to a laminated product having improved impact strength and improved strength of a weld part, and a process for producing the same.

### BACKGROUND OF THE INVENTION

Since a glass fiber reinforced thermoplastic resin has superior strength and heat resistance, it Is widely used for molding various kinds of parts such as car parts.

However, in many cases, (1) said parts have insufficient impact strength, and (2) when said parts have a weld part, strength of the weld part Is insufficient.

As a method for improving impact strength thereof, there is known a method which uses a glass fiber reinforced thermoplastic resin pellet, wherein the pellet contains fibers having a length substantially equal to that of the pellet, namely, about 3 to 20 mm length. However, parts obtained according to said method still have insufficient impact strength.

As a method for improving strength of a weld part, various molding methods are proposed. However, the strength of the weld part of parts obtained according to said methods is lower than strength of any other part than the weld part. Therefore, it is desired to improve strength of a weld part. Here, the phrase “strength of a weld part” means (i) static strength of a weld part such as flexural strength and tensile strength, and (ii) impact strength of a weld part.

### SUMMARY OF THE INVENTION

It is an object of the present invention to provide a laminated product having improved impact strength.

It is another object of the present invention to provide a laminated product having improved impact strength and improved strength of a weld part, when the laminated product has a weld part.

It is a further object of the present invention to provide a process for producing the above-mentioned laminated product.

The present invention provides a laminated product comprising;

(i) a layer containing a glass fiber reinforced thermoplastic resin, and

(ii) a layer containing a metal plate.

The present invention also provides a process for producing a laminated product, which comprises the steps of:

(i) setting a layer containing a metal plate in a mold cavity,

(ii) closing the mold,

(iii) supplying a molten resin of a glass fiber reinforced thermoplastic resin pellet in the mold cavity,

(iv) cooling and solidifying the supplied resin, and

(v) taking out a laminated product from the mold cavity.

### BRIEF DESCRIPTION OF THE DRAWINGS

FIG. 1 shows one embodiment of a laminated product in accordance with the present invention. A layer 12 containing a steel plate is laminated on a part of a layer 11, which layer contains a glass fiber reinforced thermoplastic resin, through a layer 13 containing a polar group-carrying thermoplastic resin, wherein properties such as rigidity, heat-resistance and impact-resistance are required for said part of the laminated product. FIG. 1 (1) is a strabismus figure of the laminated product, and FIG. 1 (2) shows an A-A cross sectional view of FIG. 1 (1).

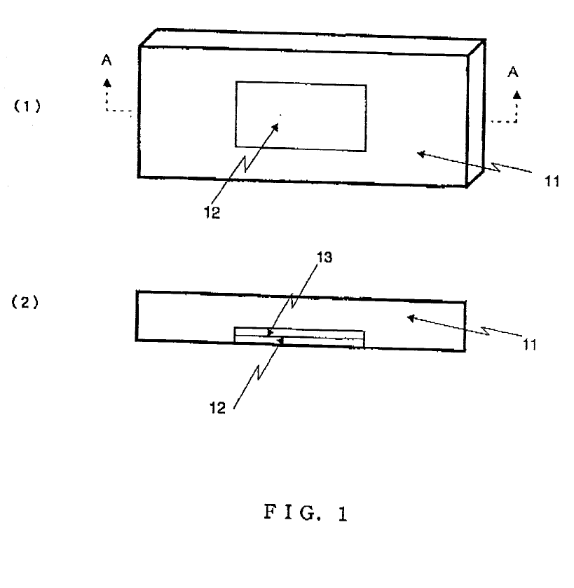

FIG. 2 shows one embodiment of a three-layered laminated product in accordance with the present invention. A layer 22 containing a steel plate is laminated on the whole surface of a layer 21, which layer contains a glass fiber reinforced thermoplastic resin, through a layer 23 containing a polar group-carrying thermoplastic resin. FIG. 2 (1) is a strabismus figure of the laminated product, and FIG. 2 (2) shows a right overhead view of the laminated product.

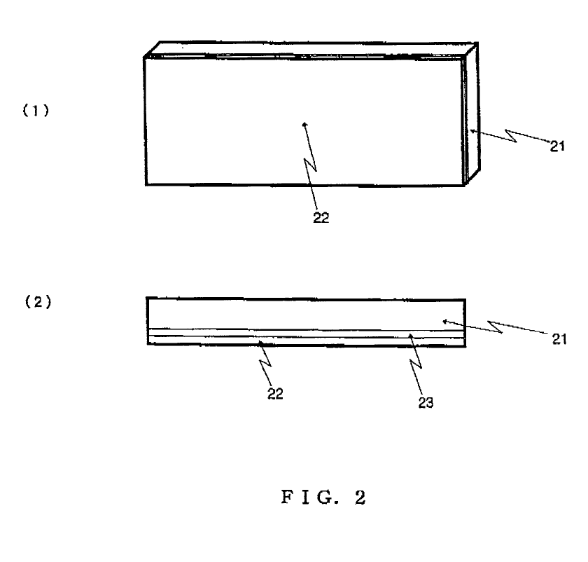

FIG. 3 shows one embodiment of a five-layered laminated product in accordance with the present invention. Respective layers 32 containing a steel plate are laminated on the whole surface of respective layers 31, which layers contain a glass fiber reinforced thermoplastic resin, through respective layers 33 containing a polar group-carrying thermoplastic resin. FIG. 3 (1) is a strabismus figure of the laminated product, and FIG. 3 (2) is a right overhead view of the laminated product.

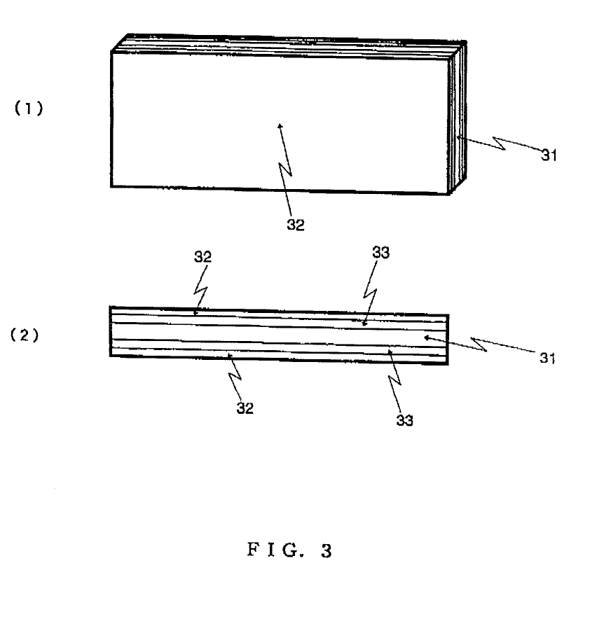

### DETAILED DESCRIPTION OF THE INVENTION

A glass fiber reinforced thermoplastic resin used in the present invention comprises a glass fiber and a thermoplastic resin.

The thermoplastic resin used in the present invention is not limited in its kind. Preferable thermoplastic resins are thermoplastic polyolefin, polyamide and polyester resins, and a combination of two or more of said resins. Among these resins, polyolefin resins are preferable, from a viewpoint of obtaining a good layer containing a glass fiber reinforced thermoplastic resin. The polyolefin resins may be either amorphous or crystalline. A crystalline polyolefin resin is more preferable.

As preferable polyolefin resins, there are exemplified polyethylene such as a high density polyethylene (HDPE); polypropylene; poly(l-butene); poly(3-methylbutene-1); poly(4-methylpentene-1); copolymer of propylene and other olefins such as a propylene-ethylene block copolymer and a propylene-ethylene random copolymer; a copolymer of propylene and a non-conjugated diene; and a combination of two or more thereof.

More preferable polyolefin resins are polypropylene resins, which contains a structure unit derived from propylene In an amount of not less than 50% by weight, and a structure unit derived from at least one olefin other than propylene in an amount of less than 50% by weight. As said polypropylene resins, a homopolymer of propylene; a block or random copolymer of propylene and at least one olefin such as ethylene and 1-butene; and a combination of two or more of these resins are exemplified.

It is particularly preferable to use said polypropylene resin in combination with a modified polyolefin resin, from a viewpoint of good adhesion between a thermoplastic resin and a glass fiber. A content of the modified polyolefin resin in the combined resin is preferably from 1 to 30% by weight, and more preferably from 3 to 20% by weight. Examples of the modified polyolefin resin are those mentioned below.

As the above-mentioned thermoplastic polyamide resin, there are exemplified polyamide-6, polyamide-11, polyamide-12, polyamide-4, 6, polyamide-6, 6, polyamide-6, 10and polyamide-6, 12, and a combination of two or more of these resins.

As the above-mentioned thermoplastic polyester resin, there are exemplified polyethylene terephthalate, polybutylene terephthalate, polycarbonate and polyester carbonate, and a combination of two or more of these resins.

The glass fiber reinforced thermoplastic resin may be used in combination with additives such as antioxidants, anti-fogging agents, anti-static agents, nucleating agents and ultraviolet ray absorvers; pigments; and recycled resins, as far as the objects of the present invention are accomplished

A content of a glass fiber in the glass fiber reinforced thermoplastic resin used in the present invention is preferably from 5 to 60% by weight, more preferably from 15 to 50% by weight, and much more preferably from 20 to 45% by weight, provided that the weight of the glass fiber reinforced thermoplastic resin is assigned to be 100% by weight. When the content is less than 5% by weight, the laminated product obtained may not have satisfactory strength, rigidity or durability. When the content exceeds 60% by weight, moldability of the glass fiber reinforced thermoplastic resin may be deteriorated; appearance of the laminated product obtained may not be good; or the laminated product having a lightweight cannot be obtained,

A preferable glass fiber reinforced thermoplastic resin used in the present invention is a resin pellet, which has a pellet length of from 2 to 100 mm, and contains from 5 to 60% by weight of a glass fiber arranged in parallel with one another. Here, the phrase “pellet length” means that every pellet has said pellet length. A length of the glass fiber in the pellet is substantially equal to the length of the pallet.

The glass fiber contained in the glass fiber reinforced thermoplastic resin is not limited in its kind. Examples thereof are filaments obtained by melt-spinning glass such as E glass (electrical glass), C glass (chemical glass), A glass (alkali glass), S glass (high strength glass) and alkali resistant glass. A fiber diameter of the glass fiber is not particularly limited, and it is preferably from 3 to 25μm, and more preferably from 8 to 20μm.

A metal plate used in the present invention has thickness of usually from 0.05 to 2 mm, preferably from 0.1 to 1 mm, and more preferably from 0.1 to 0.5 mm. When the thickness is less than 0.05 mm, the laminated product obtained may not have good strength and rigidity. When it exceeds 2 mm, (i) the laminated product obtained is too heavy, and (ii) when the layer containing the glass fiber reinforced thermoplastic resin has a curved surface, two layers, namely, a layer containing the glass fiber reinforced thermoplastic resin, and a layer containing the metal plate, may not be laminated satisfactorily with each other.

The metal plate is not limited in its kind. Examples thereof are a steel plate, an aluminum plate, a copper plate and a zinc plate. When the layer containing the metal plate has a curved surface, it is preferable to use a steel plate as the metal plate, from a viewpoint of easiness in bending and stretch forming of the layer.

Examples of the steel plate are a cold rolling steel plate (SPC), a hot rolling thin steel plate (SPN), a cold-finished band steel (SPM), a tinplate (SPTE, SPTH), a zinc iron plate (SPG) and a lightweight steel (SSC). Among these, a cold rolling steel plate (SPC) and a hot rolling thin steel plate (SPN) are preferable, and a cold rolling steel plate (SPC) is particularly preferable.

From a viewpoint of increasing adhesive strength between the layer containing the glass fiber reinforced thermoplastic resin and the layer containing the metal plate, a laminated product in accordance with the present invention has preferably a layer containing a polar group-carrying thermoplastic resin between both layers.

Examples of said polar group are acyl, amino, amido, alkoxy, isocyanato, imido, urethane, alkoxycarbonyl, acyloxy including an acryloxy group and a methacryloxy group, epoxy, oxazolyl, carboxyl including a maleic acid residual group and a maleic anhydride residual group, carbonyl, cyano, hydroxyl, sulfoxyl, sulfo, thiol, nitryl and mercapto groups.

Preferable examples of the polar group-carrying thermoplastic resin are modified polyolefin resins, which can be obtained by modifying a polyolefin (preferably a polypropylene based resin such as a propylene homopolymer and a propylene unit-containing olefin copolymer) with an unsaturated carboxylic acid such as acrylic acid; an unsaturated dicarboxylic acid such as maleic acid: a derivative such as an ester, acid anhydride, salt, amide and imide of the above-mentioned unsaturated carboxylic acid; a derivative such as an ester, acid anhydride, salt, amide and imide of the above-mentioned unsaturated dicarboxylic acid; an unsaturated alcohol such as allyl alcohol; an unsaturated amine: allyl isocyanate; or a vinylalkoxysilane. Among these, more preferable are polyolefin resins modified with said unsaturated dicarboxylic acid, unsaturated dicarboxylic anhydride or unsaturated alcohol. Much more preferable are polyolefin resins modified with maleic anhydride or a mixture of melaic anhydride and maleic acid,

The modified polyolefin resin can be produced according to a conventional process. There is exemplified a process comprising the step of reacting a polyolefin with the above-mentioned compound in the presence of a radical initiator in an extruding machine or in a solution, wherein the above-mentioned compound grafts on the polyolefin. A grafting proportion is preferably from 0.01 to 40% by weight, more preferably from 0.05 to 20% by weight, and much more preferably from 0.1 to 10% by weight, provided that a weight of the modified polyolefin resin is assigned to be 100% by weight. When the grafting proportion is less than 0.01% by weight, adhesive strength between the layer containing the glass fiber reinforced thermoplastic resin and the layer containing the metal plate is frequently unsatisfactory. When the grafting proportion exceeds 40%by weight, processability of the modified polyolefin resin may be deteriorated. When the modified polyolefin resin is used in combination with a non-modified polyolefin resin, it is preferable that a grafting proportion in the combined resin is within the above-mentioned ranges.

From a viewpoint of obtaining a laminated product having a superior rigidity, heat resistance, impact strength, design and surface hardness, and particularly from a viewpoint of obtaining a laminated product used for producing car parts such as a front end panel, preferable laminated products in accordance with the present invention comprise:

(1) a laminated product wherein the whole or a part of the surface thereof contains a layer containing a metal plate, and

(2) a laminated product wherein a layer containing a metal plate is laminated on one or both sides of a layer containing a glass fiber reinforced thermoplastic resin.

When a layer containing a glass fiber reinforced thermoplastic resin has a weld part, which layer can be molded according to a molding method such as an injection molding, injection compression molding, expansion injection molding and gas-introducing injection molding method, a laminated product having a greatly improved strength of the weld part can be obtained by laminating the weld zone with a layer containing a steel plate.

A laminated product in accordance with the present invention can be produced by a process comprising the steps of:

(i) setting a layer containing a metal plate in a mold cavity,

(ii) closing the mold,

(iii) supplying a molten resin of a glass fiber reinforced thermoplastic resin pellet In the mold cavity,

(iv) cooling and solidifying the supplied resin, and

(v) taking out a laminated product from the mold cavity.

This process does not need a step of adhering a layer containing a glass fiber reinforced thermoplastic resin, which layer is separately prepared in advance, with a layer containing a metal plate. Moreover, this process can produce efficiently a laminated product having any shape.

When producing a laminated product, wherein a layer containing a polar group-carrying thermoplastic resin is laminated between a layer containing a glass fiber reinforced thermoplastic resin and a layer containing a metal plate so as to contact with both of the latter layers, a laminated material comprising a layer containing a metal plate and a layer containing a polar group-carrying thermoplastic resin, which laminated material is separately prepared in advance, can be used in place of the layer containing the metal plate in the above-mentioned step (1). Said laminated material can be produced by a known molding method such as a press molding, laminate molding and cast molding method.

A laminated product in accordance with the present invention has extensively wide applications such as car parts and housings for household electric appliances and light current products, which applications are required to have superior impact strength, superior strength of a weld part and light weight. With respect to car parts, even a resin-made front end panel is recently proposed (cf. JP-A 11-152062), from a view point of (i) a lightweight of a car and (ii) an efficient production of a front end panel, which has a complex shape, and is required to have superior rigidity, heat resistance and impact resistance The front end panel proposed in said JP-A does not have the sufficient impact strength and the strength of a weld part. While, the laminated product in accordance with the present invention is particularly suitable for producing such a front end panel.

### EXAMPLE

The present invention is illustrated in more detail with reference to Examples, which do not limit the scope of the present invention.

A molding method and test methods used are as follows.

1. Injection Molding

(1) Injection Molding Machine

An injection molding machine (FS 160S25 ASEN) manufactured by Nissei Plastic Industrial Co., Ltd. was used.

(2) Mold for Injection Molding

A mold having a cavity In a flat-plate shape of 90 mm (width)×150 mm (length)×3 mm (thickness), and having two gates on its both sides in the longitudinal direction thereof was used. Respective gates can be switched to open or close. When either gate of said gates is opened, a molded product having no weld is obtained, and when both gates are opened, a molded product having a weld zone at its center portion in the longitudinal direction is obtained.

(3) Conditions for Injection Molding

A cylinder temperature was set at 250° C., a mold temperature was set at 50° C., a screw rotation was set at 30 rpm, and a back pressure was set at 0 MPa.

2. Melt Flow Rate (MFR)

MFR was measured according to JIS K7210, wherein MFR of a polypropylene based resin was measured according to a method prescribed in Table 1, Condition 14.

3. Flexural Modulus (MPa) and Flexural Strength (MPa)

An injection molded product having a flat-plate shape was cut out in a direction parallel to the direction of the resin flow to obtain a sample, which was then measured according to a method prescribed in JIS-K-7203.

4. Impact strength (kj/m²)

Using an impact measurement apparatus, a trademark of DYNSTAT IMPACT TESTER, manufactured by Tester Sangyo Co., Ltd., impact strength was measured according to the test method, DIN 53453, by the process comprising the steps of:

(1) cutting out an injection molded product having a flat-plate shape to obtain a test piece having a size of 10 mm×22 mm×3 mm (thickness),and when the injection molded product has a weld part, cutting out the injection molded product so that the test piece obtained has the weld part at a position of 12.5 mm distant from a lower end of the test piece,

(2) keeping the test piece in a thermostat for 24 hours at 23° C.,

(3) fixing the whole area having a width of 12.5 mm distant from a lower end of the test piece with a chuck of DYNSTAT IMPACT TESTER, and

(4) striking the test piece in a thickness direction thereof at a position of 7 mm upward from the end of the chick, thereby measuring its impact strength.

### Example 1

On a cold rolling steel plate (SPC) of 180 mm×180 mm×0.1 mm (thickness), was placed 3 g of a pellet of a modified polyolefin (MFR=40 g/10 min, grafting proportion of maleic anhydride=0.2% by weight), which was obtained by modifying an ethylene-propylene block copolymer with maleic anhydride. Said ethylene-propylene block copolymer contained (i) the ethylene-propylene random copolymer and (ii) the propylene homopolymer, wherein the content of the ethylene-propylene random copolymer in the ethylene-propylene block copolymer was 22% by weight, and the ethylene unit content in the ethylene-propylene random copolymer was 45% by weight.

Using a press machine, NF-37, manufactured by Shinto Metal Industries Co., Ltd., the steel plate and the modified polyolefin thereon were pressed and melt-adhered at 200 ° C. for two minutes under a pressure of 200 N/cm²-film, thereby obtaining a laminated material, A thickness of the maleic anhydride-modified polypropylene layer in the laminated material obtained was found to be about 0.11 mm.

The laminated material obtained was cut into a piece having a size of 90 mm×90 mm. The steel layer of the piece was contacted tightly with a surface of the mold cavity wall of an injection molding machine, and then the mold was closed.

A molten glass fiber reinforced thermoplastic resin, a trade name of SUMISTRAN (glass fiber content=40%, pellet length=9 mm), manufactured by Sumitomo Chemical Co., Ltd., was supplied into the mold through one gate of the mold, thereby obtaining a laminated product of 90 mm×150 mm×3 mm, wherein the glass fibers in the pellet had a length substantially equal to that of the pellet, and were arranged in parallel with one another.

Flexural modulus, flexural strength and impact strength of the laminated product obtained are as shown in Table 1, which summarizes the results of a test piece having no weld part.

### Example 2

Example 1 was repeated, except that two pieces were contacted tightly with both surface of the mold, respectively, thereby obtaining a laminated product having respective steel plate layers on both surfaces of the laminated product-The results are as shown in Table 1.

### Example 3

Example 1 was repeated, except that a steel plate having thickness of 0.2 mm was used, there by obtaining a laminated product having a steel plate layer on one surface thereof. The results are as shown in Table 1.

### Example 4

Example 2 was repeated, except that a steel plate having thickness of 0.2mm was used, there by obtaining a laminated product having two steelplate layers on both surfaces thereof. The results are as shown in Table 1.

### Comparative Example 1

Example 1 was repeated, except that no laminated material piece was placed in the mold, thereby obtaining a molded product. The results are as shown in Table 1.

### Example 5

Example 1 was repeated, except that the molten glass fiber reinforced thermoplastic resin was supplied into the mold through two gates of the mold, thereby obtaining a laminated product having a steel plate layer on one surface thereof, and having a weld part at a center portion thereof. The results are as shown in Table 2, which summarizes the results of a test piece having a weld part.

### Example 6

Example 2 was repeated, except that the molten glass fiber reinforced thermoplastic resin was Supplied into the mold through two gates of the mold, there by obtaining a laminated product having respective steel plate layers on both surfaces thereof, and having a weld part at a center portion thereof. The results are as shown in Table 2.

### Example 7

Example 3 was repeated, except that the molten glass fiber reinforced thermoplastic resin was supplied into the mold through two gates of the mold, thereby obtaining a laminated product having a steel plate layer on one surface thereof, and having a weld part at a center portion thereof. The results are as shown in Table 2.

### Example 8

Example 4 was repeated, except that the molten glass fiber reinforced thermoplastic resin was supplied into the mold through two gates of the mold, thereby obtaining a laminated product having two steel plate layers on both surfaces thereof, and having a weld part at a center portion thereof. The results are as shown in Table 2.

### Comparative Example 2

Example 5 was repeated, except that no laminated material piece was placed in the mold, thereby obtaining a molded product having a weld part at the center portion thereof. The results are as shown in Table 2.

The phrase “evaluation directions” in Tables 1 and 2 means:

(i) a pressed surface of the test piece in the evaluation of the flexural modulus and the flexural strength, and

(ii) a struck surface of the test piece in the evaluation of the impact strength.

With respect to Examples 2 and 4 whose test pieces have two steel plate layers, respectively, and Comparative Examples 1 and 2 whose test pieces have no steel plate layer, it is not necessary to consider the evaluation direction.

TABLE 1

| | | | | | Com- |
|---|---|---|---|---|---|
| | | | | | para- |
| | Ex- | Ex- | Ex- | Ex- | tive |
| | ample | ample | ample | ample | Ex- |
| | 1 | 2 | 3 | 4 | ample 1 |
| Thickness of steel plate | 0.1 | 0.1 | 0.2 | 0.2 | — |
| (mm) | | | | | |
| Surface laminated with | one | Both | one | both | None |
| steel plate | side | sides | side | sides | |
| Evaluation direction | resin | — | resin | — | — |
| | side | | side | | |
| 23° C. | | | | | |
| Flexural modulus (MPa) | 13300 | 24800 | 14600 | 36800 | 5870 |
| Flexural strength (MPa) | 215 | 249 | 256 | 341 | 138 |
| Impact strength (kJ/m²) | 25.0 | 41.9 | — | 65.2 | 23.1 |
| 110° C. | | | | | |
| Flexural modulus (MPa) | — | 13100 | — | 17900 | 3320 |
| Flexural strength (MPa) | — | 145 | — | 250 | 61 |
| Evaluation direction | steel | — | steel | — | — |
| | plate | | plate | | |
| | side | | side | | |
| 23° C. | | | | | |
| Flexural modulus (MPa) | 11500 | — | 13300 | — | — |
| Flexural strength (MPa) | 165 | — | 176 | — | — |
| Impact strength (kJ/m²) | 39.0 | — | — | — | — |

TABLE 2

| | | | | | Com- |
|---|---|---|---|---|---|
| | | | | | para- |
| | Ex- | Ex- | Ex- | Ex- | tive |
| | ample | ample | ample | ample | Ex- |
| | 5 | 6 | 7 | 8 | ample 2 |
| Thickness of steel plate | 0.1 | 0.1 | 0.2 | 0.2 | — |
| (mm) | | | | | |
| Surface laminated with | one | both | one | both | none |
| steel plate | side | sides | side | sides | |
| Evaluation direction | resin | — | resin | — | — |
| | side | | side | | |
| 23° C. | | | | | |
| Flexural modulus (MPa) | 10600 | 21000 | 11200 | 32400 | 4420 |
| Flexural strength (MPa) | 173 | 220 | 198 | 291 | 51 |
| Impact strength (kJ/m²) | 4.3 | 17.6 | 6.5 | 43.0 | 3.0 |
| 110° C. | | | | | |
| Flexural modulus (MPa) | — | 11600 | — | 16700 | 2300 |
| Flexural strength (MPa) | — | 125 | — | 195 | 20 |
| Evaluation direction | steel | — | steel | — | — |
| | plate | | plate | | |
| | side | | side | | |
| 23° C. | | | | | |
| Flexural modulus (MPa) | 9900 | — | 10400 | — | — |
| Flexural strength (MPa) | 80 | — | 67 | — | — |
| Impact strength (kJ/m²) | 13.8 | — | 38.9 | — | — |

1. A laminated product comprising:
(i) a layer containing a glass fiber reinforced thermoplastic resin, and
(ii) a layer containing a metal plate.

2. The laminated product according to claim 1, wherein a layer containing a polar group-carrying thermoplastic resin is laminated between the layer containing a glass fiber reinforced thermoplastic resin, and the layer containing a metal plate so as to contact with both of the latter layers.

3. The laminated product according to claim 1, wherein at least a part of the surface of the laminated product comprises the layer containing a metal plate.

4. The laminated product according to claim 1, wherein the layer containing a metal plate is laminated on one side of the layer containing a glass fiber reinforced thermoplastic resin.

5. The laminated product according to claim 1, wherein the layer containing a metal plate is laminated on both sides of the layer containing a glass fiber reinforced thermoplastic resin.

6. The laminated product according to claim 1, wherein the glass fiber reinforced thermoplastic resin contains a glass fiber reinforced polypropylene resin.

7. The laminated product according to claim 1, wherein the glass fiber reinforced thermoplastic resin has from 5 to 60% by weight of a glass fiber.

8. The laminated product according to claim 1, wherein the thermoplastic resin in the glass fiber reinforced thermoplastic resin is combined with a modified polyolefin resin.

9. The laminated product according to claim 1, wherein the layer containing a steel plate is laminated on a weld part of the layer containing a glass fiber reinforced thermoplastic resin.

10. The laminated product according to claim 1, wherein the metal plate has thickness of from 0.05 to 2 mm.

11. The laminated product according to claim 1, wherein the metal plate contains a steel plate.

12. The laminated product according to claim 1, wherein the laminated product is a front end panel for a car.

13. A process for producing a laminated product, which comprises the steps of:
(i) setting a layer containing a metal plate in a mold cavity,
(ii) closing the mold,
(iii) supplying a molten resin of a glass fiber reinforced thermoplastic resin pellet in the mold cavity,
(iv) cooling and solidifying the supplied resin, and
(v) taking out a laminated product from the mold cavity.

14. The process for producing a laminated product according to claim 13, wherein the glass fiber reinforced thermoplastic resin pellet in the step (iii) contains from 5 to 60% by weight of a glass fiber arranged in parallel with one another, and has a pellet length of from 2 to 100 mm.

15. The process for producing a laminated product according to claim 13, wherein:
(1) the layer containing a glass fiber reinforced thermoplastic resin is molded according to an injection molding, injection compression molding, expansion injection molding or gas-introducing injection molding method, and
(2) the layer containing a metal plate is laminated on a weld part of the layer containing a glass fiber reinforced thermoplastic resin.

16. The process for producing a laminated product according to claim 13, wherein the layer containing a metal plate in the step (i) is a laminated material layer comprising;
(1) a metal plate layer, and
(2) a layer containing a polar group-containing thermoplastic resin.

17. The process for producing a laminated product according to claim 13, wherein at least a part of the surface of the laminated product comprises the layer containing a metal plate.

18. The process for producing a laminated product according to claim 13, wherein the layer containing a metal plate is laminated on one side of the layer containing a glass fiber reinforced thermoplastic resin.

19. The process for producing a laminated product according to claim 13, wherein the layer containing a metal plate is laminated on both sides of the layer containing a glass fiber reinforced thermoplastic resin.

20. The process for producing a laminated product according to claim 13, wherein the glass fiber reinforced thermoplastic resin in the step (iii) comprises a glass fiber reinforced polypropylene resin.

21. The process for producing a laminated product according to claim 13, wherein the thermoplastic resin in the glass fiber reinforced thermoplastic resin in the step (iii) is combined with a modified polyolefin resin.

22. The process for producing a laminated product according to claim 13, wherein the metal plate has thickness of from 0.05 to 2 mm.

23. The process for producing a laminated product according to claim 13, wherein the metal plate contains a steel plate.

24. The process for producing a laminated product according to claim 13, wherein the laminated product is a front end panel.
